(19) United States
(12) Patent Application Publication
(10) Pub. No.: US 2026/0220541 A1
(43) Pub. Date: Jul. 30, 2026

(54) DYNAMIC DATA INGESTION FOR DEPLOYING MACHINE LEARNING MODELS

(71) Applicant: PAYPAL, INC., San Jose, CA (US)

(72) Inventors: Yu Zhang, Shanghai (CN); Haoran Zhang, Shanghai (CN); Xia Zhang, Shanghai (CN); Zhe Huang, Shanghai (CN); Xiaojun Luan, Shanghai (CN); Ying Yue, Shanghai (CN); Junshi Guo, Shanghai (CN); Delin Liu, Shanghai (CN); Renhua Liang, Shanghai (CN); Ruoqi Liu, Shanghai (CN)

(21) Appl. No.: 19/212,265

(22) Filed: May 19, 2025

Related U.S. Application Data
(63) Continuation of application No. PCT/CN2025/075122, filed on Jan. 26, 2025.

(51) Int. Cl. G06N 20/00

(52) U.S. Cl. CPC G06N 20/00

(57) ABSTRACT

Methods and systems are presented for providing a graph-based framework for evaluating feature candidates for a machine learning model. A production graph is generated to represent relationships among various assets of an organization. The production graph is used by various machine learning models for obtaining input data to perform the corresponding tasks. When it is determined that data corresponding to a feature candidate selected for the machine learning model is missing from the graph, instead of modifying the production graph, a new graph schema that defines one or more additional vertex types or one or more additional edge types is generated. New graph data is also generated based on the new graph schema. In response to a query corresponding to the feature candidate, a merged graph is generated by incorporating the new graph data into the production graph. A query result is obtained based on traversing the merged graph.

### CROSS REFERENCE TO RELATED APPLICATION

The present application is a Continuation of International Application Serial No. PCT/CN2025/075122, filed Jan. 26, 2025, which is hereby incorporated by reference in its entirety as if fully set forth below and for all applicable purposes.

### BACKGROUND

The present specification generally relates to machine learning models, and more specifically, to a computer-based framework for constructing and deploying machine learning models according to various embodiments of the disclosure.

### RELATED ART

Machine learning models have been widely used to perform various tasks for organizations. For example, machine learning models may be used in classifying data (e.g., determining whether a transaction is a legitimate transaction or a fraudulent transaction, determining whether a merchant is a high-value merchant or not, determining whether a user is a high-risk user or not, etc.). To construct a machine learning model, a set of input features that are related to performing a task associated with the machine learning model are identified and defined. Training data that includes attribute values corresponding to the set of input features and labels corresponding to pre-determined prediction outcomes may be provided to train the machine learning model. Based on the training data and labels, the machine learning model may learn patterns associated with the training data, and provide predictions based on the learned patterns. For example, new data (e.g., transaction data associated with a new transaction) that corresponds to the set of input features may be provided to the machine learning model. The machine learning model may perform a prediction for the new data based on the learned patterns from the training data (e.g., whether the new transaction is a legitimate transaction or not, etc.).

While machine learning models are effective in learning patterns and making predictions, they are limited by the input features identified at the time of construction. When a set of input features selected for a machine learning model is highly relevant to the task performed by the machine learning model (e.g., highly related to the prediction performed by the model), the machine learning model can be trained to perform the task with high accuracy. Conversely, when the set of input features selected for the machine learning model is not relevant to the task, the machine learning model would likely perform the task poorly (e.g., inaccurate prediction), even with a large amount of training data. To further complicate the problem, data trends and patterns shift frequently, such that a feature that was determined to be highly relevant to performing the task some time ago may no longer be relevant, and a feature that was determined to be not relevant to performing the task before may become relevant. Thus, there is a need for providing a computer-based tool for efficiently identifying and evaluating features for machine learning models.

### BRIEF DESCRIPTION OF THE FIGURES

FIG. 1 is a block diagram illustrating an electronic transaction system according to an embodiment of the present disclosure;

FIG. 2 illustrates a transaction processing module according to an embodiment of the present disclosure;

FIG. 3 illustrates using modified graph schemas and additional graph data to facilitate access to feature candidates according to an embodiment of the present disclosure;

FIG. 4 illustrates an example of graph merging operations according to an embodiment of the present disclosure;

FIG. 5 illustrates another example of graph merging operations according to an embodiment of the present disclosure;

FIG. 6 is a flowchart showing a process of generating additional graph schemas and graph data for providing access to data corresponding to a feature candidate according to an embodiment of the present disclosure;

FIG. 7 is a flowchart showing a process of processing a query for data corresponding to a feature candidate according to an embodiment of the present disclosure;

FIG. 8 illustrates an example neural network that can be used to implement a machine learning model according to an embodiment of the present disclosure; and

FIG. 9 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes methods and systems for providing a computer-based framework for configuring and deploying machine learning models. One of the critical aspects for configuring and deploying a machine learning model is to select high quality input features for the machine learning model. As discussed herein, selecting high quality input features for a machine learning model, a process that is also known as “feature engineering,” is crucial to improving the prediction accuracy performance of a machine learning model. An input feature for a machine learning model refers to a variable type (or an attribute type) corresponding to one of the inputs of the machine learning model. Once input features are defined for the machine learning model, data corresponding to the input features (e.g., variables corresponding to the variable types, attribute values corresponding to the attribute types) may be provided to the machine learning model as input values that are used by the machine learning model to perform a prediction task. For example, when a machine learning model is configured to classify a transaction, the input features may include a transaction amount, a transaction type, a network address associated with a device that initiates the transaction, and so forth. In order for the machine learning model to classify any given transaction, input data corresponding to the input features and associated with a transaction (e.g., a numeric value corresponding to the transaction amount of the transaction, a string of characters corresponding to the transaction type of the transaction, a value corresponding to the network address of the device that initiates the transaction, etc.) may be provided to the machine learning model. The machine learning model may then use the input data to generate an output representing a classification of the transaction based on one or more patterns that were “learned” during a training phase of the machine learning model.

For any given task, a large number of potential features (also referred to as “feature candidates”) can be available for use by the machine learning model. However, it is impractical and likely detrimental to the prediction accuracy performance of the machine learning model if all of the feature candidates are selected as input features for the machine learning model. It is because the large amount of input data may cause the machine learning model to consume an unnecessarily large amount of computer resources and time to perform the task each time. In addition, while some of the feature candidates may be useful for the machine learning model in performing the task, some other feature candidates may not be useful (or may even be detrimental) to the performance of the task. For example, when the machine learning model is configured to classify transactions, example feature candidates may include a transaction amount, a network address associated with a device that initiates the transaction, a first name of the person who initiates the transaction, a number of transactions conducted by the person in the past year, a number of different entities that the person has conducted transactions with in the past year, a location of the transaction, or any other information related to the transaction. While some of the features (e.g., a transaction amount, a network address of a device, etc.) may be useful and relevant for the machine learning model to predict a classification of the transaction, some of the other features (e.g., a first name of the person, etc.) may not be as useful or relevant for the machine learning model to predict the classification of the transaction. As such, it is crucial to select highly relevant input features (e.g., input features that have a high correlation to the desired output of the machine learning model) for the machine learning model.

Conventionally, the process of selecting input features for a machine learning model (feature engineering) is a complex process that requires experts across different domains, such as data scientists, specialized software programmers, etc., to work together for an extended period of time to generate and evaluate the quality of different feature candidates. The data scientists may determine feature candidates that can potentially be used by the machine learning model, and evaluate each of the feature candidates (e.g., determine whether a correlation between the feature candidate and an output of the machine learning model exceeds a threshold, etc.). The evaluation process for each feature candidate may involve accessing (e.g., querying) multiple records (corresponding to multiple transactions conducted in the past) that include data corresponding to the feature candidate and associated with the multiple transactions, and determine whether the data corresponding to the feature candidate correlates to a label of the record (e.g., whether the transaction is a legitimate transaction or not, etc.). The process is further complicated when the data that can be used to identify features is embedded within a graph structure, as many organizations have adopted the use of graph structures for storing and organizing data.

Graph structures are a type of data structure that uses vertices to represent different assets associated with an organization, such as user accounts, users, user devices, network address of user devices, etc. The vertices can be connected with each other via one or more edges representing one or more types of relationships. As such, storing data in a graph structure is advantageous for representing and/or illustrating relationships among different assets. For example, a social media platform can use a graph structure to represent the different users and the relationships among the different users with the social media platform. In this example, each user may be represented by a distinct vertex in a graph, and a relationship between two users (e.g., a friendship relationship, a spousal relationship, a sibling relationship, etc.) can be represented by an edge between the two corresponding vertices in the graph.

In another example, an online payment provider may use a graph structure to represent user accounts with the payment provider. In this example, each user account may be represented by a distinct vertex in a graph, and each payment transaction conducted between two accounts may be represented by an edge connecting the two corresponding vertices. In some embodiments, the online payment provider may also use different types of vertices to represent different assets or attributes. For example, in addition to user accounts, the online payment provider may also use other types of vertices to represent other types of assets or attributes, such as network addresses (e.g., an Internet Protocol address, an email address, etc.) associated with devices of users, device identifiers associated with devices of users, physical locations (e.g., residential addresses of users, etc.), funding sources (e.g., a credit card account, a debit card account, etc.), and other data relevant to payment transactions. Vertices may then be connected via different types of edges based on different types of relationships. For example, when a user account uses a particular device to conduct a transaction, an edge (representing a device usage relationship) may connect the vertex representing the user account and the vertex representing the particular device. When two user accounts have conducted payment transactions using the same device, the two vertices representing the two user accounts would be connected to the same vertex representing the device. As such, certain data and/or relationships among different assets, which may not be represented (or difficult to represent) in a conventional data structure (e.g., a relational database system, etc.), can be clearly represented using a graph structure.

By storing data in a graph structure, additional feature candidates (that may not be readily available when the data is stored in a different data structure) may become available for configuring various machine learning models for performing different tasks. Using the example illustrated above where the graph includes edges that connect user accounts that are associated with the same devices, the graph structure enables an input feature, representing the number of user accounts sharing the same device used to conduct a transaction, to be used by the machine learning model for classifying transactions. Such an input feature has become available based on the graph structure because input data corresponding to this input feature may be readily accessed (e.g., queried) using the graph structure. For example, when classifying a transaction conducting through a user account, a computer system may locate a vertex representing the user account in the graph, and hop to another connected vertex that represents a user device associated with the user account in the graph. The computer system may then determine the number of connecting vertices representing various user accounts that share the same user device based on the vertex data associated with the vertex representing the user device. On the other hand, such an input feature may not be available when the data is stored in a conventional data structure (e.g., a relationship database system, etc.) because the input data corresponding to the input feature may be difficult to obtain within the conventional data structure (e.g., may require multiple data queries and/or multiple computer processing steps to obtain such data, etc.), as the relationship between user devices and user accounts is not represented in any of the data in the conventional data structure.

With the graph structure in place, the computer system and/or data scientists may have enhanced flexibility in selecting input features for various machine learning models. However, the graph structure also has its limitations. For example, the process of generating a graph based on underlying data (e.g., data associated with the organization) stored in the one or more databases can require a substantial amount of computer resources and time. Due to the required computer resources and time to generate the graph, once the graph is generated, it typically is not frequently modified, which limits the ability for the computer system and/or the data scientists from testing and/or evaluating different newer feature candidates for various machine learning models.

As such, according to various embodiments of the disclosure, a framework is provided for constructing and deploying machine learning models by enabling evaluations of different feature candidates without modifying a graph associated with an organization. A computer system associated with the organization may initially store data associated with the organization, such as user data, transaction data, device data, etc., in one or more databases (e.g., a relational database system, etc.). In order to provide an enhanced ability to evaluate and select input features for various machine learning models based on relationships among different assets, the computer system may use the data stored in the one or more databases (also referred to as the “underlying data”) to generate a graph to represent various assets and the relationships among the different assets.

The computer system may first determine a graph schema for the graph. The graph schema specifies (or defines) one or more types of vertices and one or more types of edges for the graph. The one or more types of vertices (or vertex types) may represent one or more types of assets associated with the organization, and the one or more types of edges (or edge types) may represent one or more types of relationships between assets. For example, the computer system may generate a graph schema that specifies a first type of vertex representing user accounts with the organization, and a first type of edge representing transactions conducted among the user accounts. The computer system may then construct the graph (e.g., generating graph data representing different vertices and edges of the graph) based on at least a portion of the underlying data obtained from the one or more databases of the organization. For example, the computer system may analyze the data stored in the one or more databases. The computer system may retrieve portions of the data that are relevant for constructing the graph according to the graph schema (data that is usable for constructing the vertices and the edges of the graph), and use the portions of the data to generate graph data for the graph. The graph data may include vertex data associated with different vertices generated for the graph and edge data associated with different edges generated to connect different vertices in the graph.

When the graph schema specifies a first type of vertex representing user accounts with the organization, the computer system may obtain user account data from the one or more databases, and generate vertex data based on user account data associated with each user account. The vertex data of each vertex may include various attribute values corresponding to different attribute types and related to the corresponding user account (e.g., an account identifier, a user name, a first name of the user, a last name of the user, identifier(s) of edge(s) connected to the vertex, etc.). As such, the vertex data associated with a vertex may include identities of one or more edges that are connected to the vertex in the graph. When the graph schema specifies a type of edge representing transactions conducted between user accounts, the computer system may obtain transaction data from the one or more databases, and generate edge data based on transaction data associated with each transaction. The edge data of each edge may include attribute values corresponding to different attribute types and related to the corresponding transaction (e.g., a transaction amount, a source party for the transaction, a recipient part for the transaction, etc.). As such, the edge data associated with an edge may also include identities of vertices that the edge connect in the graph. Based on the graph data, the computer system may render a visual representation of the graph with vertices connected by edges based on the graph data. The computer system may also obtain different data by traversing across different vertices in the graph via the edges.

In some embodiments, the graph data is stored in a production environment, similar to the underlying data stored in the one or more databases. As such, the graph data may be updated, along with the underlying data stored in the one or more databases, based on activities (e.g., transactions) that occur in real-time. By storing the graph data in the production environment, the computer system may query data from the one or more databases and/or the graph data to be used by one or more of the machine learning models for processing transactions.

Once the graph is generated, the computer system and/or the data scientist may analyze the graph data and the underlying data to evaluate different feature candidates and select input features for various machine learning models. For example, the computer system and/or the data scientist may determine one or more feature candidates for a machine learning model configured to classify transactions based on the graph data and the data stored in the one or more databases. The feature candidates may include data types that can be obtained from the underlying data and data types that can be obtained and/or derived from the graph. Example data types that can be obtained and/or derived from the graph may include a transaction frequency and volume associated with a user account (which can be obtained from vertex data associated with a vertex representing the user account) and identities of counterparties in transactions conducted through the user account (which can be obtained by performing one-hop operations from the vertex representing the user account).

However, the feature candidates available to the computer system and/or the data scientists are limited to the data types that are accessible from the graph according to the graph schema. For example, if the initial graph schema only defines a vertex type that represents user accounts and an edge type that represents transactions conducted among user accounts, the feature candidates may be limited to data types that are related to the user accounts and transactions.

As new data types become available and/or behavior patterns (e.g., user behavior patterns, transaction behavior patterns, etc.) shift, the computer system and/or the data scientists may desire to evaluate different feature candidates to be used in one or more machine learning models to improve the prediction performance of the machine learning models. Some of these new data types or feature candidates determined by the computer system and/or the data scientists may not be accessible in (e.g., may be missing from) the graph. For example, the computer system may desire to evaluate a new feature candidate representing a number of user accounts that share the same device used in a transaction, which is not available in the current graph and which is difficult to access in the underlying data in the one or more databases.

In order for the computer system to access and evaluate this new feature candidate, the computer system may modify the graph to include data corresponding to this new feature candidate. For example, the computer system may modify the graph schema to include additional types of vertices and/or additional types of edges, such as an additional type of vertex representing user devices and an additional type of edge representing a usage of a user device when conducting a transaction through a user account. The computer system may then modify the graph based on the modified graph schema. The process of modifying the graph is similar to the process of initially constructing the graph. For example, the computer system may traverse and analyze the underlying data in the one or more databases, retrieve portions of the data in the one or more databases related to the new vertex type and the new edge type, and modify the graph data based on the portions of the data retrieved from the one or more databases. However, such a graph modification process to accommodate evaluation of new feature candidate is inefficient in terms of computer resources usage, as modifying the graph requires a substantial amount of computer resources and time, especially given the amount of underlying data stored in the one or more databases. In addition, modifying the production graph may cause unnecessary downtime for processing transactions (e.g., the graph may not be accessible during the modification process), which can cause substantial delays in processing transactions.

Since the computer system may desire to evaluate multiple new feature candidates, such a modification process may be required to be performed multiple times. To further exacerbate the problem, the computer system may ultimately determine to use only a subset of the new feature candidates (or determine to not use any of the new feature candidates) after the evaluation. When it is determined that a feature candidate is not needed, the computer system may be required to revert the graph back to the original graph by removing any portions of the graph data related to the new feature candidate, since it is inefficient to store unneeded data in the graph (which requires frequent maintenance and updates).

As such, the framework as disclosed herein provides a mechanism for the computer system and/or the data scientists to access data associated with new feature candidates in a production graph without requiring any modification to the production graph. Specifically, the framework enables the computer system to query data corresponding to the new feature candidates as if the data is part of the graph (even though the graph is not modified and at least some of the data is not actually stored in the graph). By enabling the computer system to query data corresponding to the new feature candidates from the graph, the computer system may analyze and evaluate the new feature candidates (e.g., determining a relevancy of the new feature candidates in the task performed by the machine learning model) without requiring the graph to be modified. Since the graph is not modified to accommodate the new feature candidate, it eliminates any reversion steps needed for removing the extraneous graph data if the new feature candidate is subsequently not selected to be used in any machine learning models.

According to the framework, the computer system may determine to evaluate a new feature candidate (or receive a request to evaluate a new feature candidate from an application via an interface). When the computer system determines that data corresponding to the new feature candidate is not accessible (e.g., missing) from the underlying data or the graph based on the graph schema, the computer system may generate a new graph schema by modifying the existing graph schema associated with the graph. For example, the computer system may generate the new graph schema based on adding one or more vertex types and/or one or more edge types. Using the example illustrated above where the original graph schema only includes a vertex type representing user accounts and an edge type representing transactions conducted among user accounts, the computer system may determine that a new feature candidate (e.g., a feature representing a number of user accounts sharing the same user device, etc.) requires a new vertex type and/or a new edge type. As such, the computer system may generate a new graph schema (which may be a temporary graph schema generated for the purpose of evaluating the new feature candidate) based on the new feature candidate. For example, the computer system may generate the new graph schema by adding, to the existing graph schema, a new vertex type representing user devices and a new edge type representing a usage of user devices in transactions conducted through user accounts.

In some embodiments, instead of modifying the graph data of the original graph based on the new graph schema, the computer system generates separate graph data for the new graph schema. The new graph data is separate from the existing graph data for the original graph (e.g., the production graph), and includes only graph data that is different (e.g., missing from) the original graph based on the new graph schema. For example, the new graph data may include vertex data associated with vertices that represent various user devices used to conduct transactions with the organization, and edge data associated with edges that represent usage of the user devices in the transactions conducted through various user accounts. The computer system may obtain the new vertex data and the new edge data by traversing and analyzing the underlying data stored in the one or more databases of the organization, and retrieve portions of the data that are related to the new vertices and the new edges. The new graph data may not include any of the graph data that exists in the original graph. Since the new graph data only includes vertex data and edge data associated with the new vertex type and/or the new edge type specified in the modified graph schema, the new graph data may be insufficient for rendering a graph by itself, but may be combined with the original graph data to generate a merged graph. In some embodiments, the new graph data is stored in an environment (e.g., a research environment, etc.) different from the production environment within which the original graph data resides. As such, while the original graph data may be updated based on activities performed (e.g., transactions conducted, etc.) in real-time, the new graph data may not be updated after it is generated to ensure that the evaluation of the new feature candidate is consistent.

Once the new graph data is generated, the computer system may query (or enable one or more applications to query) data from the graph according to the modified graph schema as if the original graph has been modified based on the modified graph schema. For example, the computer system may provide a query engine that is configured to accept queries associated with modified graph schemas. When the query engine receives a query, the query engine may determine whether the query requires data corresponding to the new feature candidate (data corresponding to the vertex type(s) and/or the edge type(s) that are not included in the original graph schema). If the query requires data corresponding to the new feature candidate, instead of directly querying the original graph (e.g., the production graph), the query engine may first generate a merged graph by combining the original graph data with the new graph data (or by combining a portion of the original graph data with a portion of the new graph data). For example, the query engine may determine which portion(s) of the original graph data and which portion(s) of the new graph data are relevant to the query, extract only the portion(s) of the original graph data and the portion(s) of the new graph data, and merge the portion(s) of the original graph data with the portion(s) of the new graph data. Merging only the relevant portions of the graph data (instead of merging the entire original graph data with the entire new graph data) enables a substantial reduction of computer resources usage (e.g., computer processing resources, computer memory resources, etc.). The merged graph will include vertices and edges according to the modified graph schema. The query engine may then execute the query against the merged graph, and generate a response to the query using data obtained and/or derived from the merged graph.

For example, the query may be associated with data representing a number of other user accounts that share the same user device as a particular user account. Due to the merging of the original graph data and the new graph data, the merged graph includes user account vertices that represent user accounts and user device vertices that represent user devices. The merged graph also includes transaction edges that connect user account vertices. These transaction edges represent transactions conducted among user accounts. The merged graph also includes device usage edges that connect user account vertices with user device vertices. These device usage edges represent a usage of user devices in transactions conducted through the corresponding user accounts.

The computer system may then locate a user account vertex in the merged graph that represents the particular user account, and hop to a user device vertex that represents a user device based on a device usage edge that connects the user account vertex representing the particular user account to the user device vertex representing the user device. The computer system may then determine a number of edges connected to the user device vertex (e.g., representing the number of user accounts that use the user device to conduct transactions, etc.), and generate a response to the query based on the number of edges.

The computer system may query different data corresponding to the same new feature candidate multiple times (for different user devices used in different transactions, etc.), and may evaluate the feature candidate based on its correlation to a task performed by a machine learning model (e.g., a correlation level between the number of user accounts that share the same user device and a classification of transactions, etc.). After the evaluation, the computer system may determine to either use the feature candidate as an input feature for the machine learning model (when the correlation level exceeds a threshold) or discard the feature candidate from being used in the machine learning model (when the correlation level is below a threshold). If the computer system determines to discard the feature candidate, the computer system may remove the new graph data and the new graph schema without having to modify the original graph data.

On the other hand, if the computer system determines to use the new feature candidate as an input feature for the machine learning model, the computer system may incorporate the new graph data into the original graph data, such that the original graph is modified (e.g., expanded) based on the new graph schema. This way, data corresponding to the new feature candidate can be obtained based on the graph of the organization, for example, when training the machine learning model and/or using the machine learning model to perform a task (e.g., classifying transactions, etc.). The machine learning model may be configured to accept input data corresponding to the new feature candidate, and deployed for use in the production environment.

In some embodiments, the framework enables the computer system to simultaneously evaluate different new feature candidates. For example, the computer system may generate different modified graph schemas for different new feature candidates (each modified graph schemas generated based on modifying the original graph schema). The computer system may also generate different new graph data for the different modified graph schemas. The new graph data for the different modified graph schemas may be stored separately from each other, such that the computer system may access them independently from each other. The computer system may then evaluate each of the new feature candidates separately and compare the different new feature candidates based on their relevancy (e.g., correlations) with the task performed by the machine learning model. Based on the comparison, the computer system may select one or more of the new feature candidates as new input features for the machine learning model. The computer system may then modify the original graph data to incorporate the new graph data corresponding to the selected new input features, such that the computer system may query the modified graph data for subsequently training and/or using the machine learning model. Such a framework improves the accuracy of a machine learning model without the time and computing resources needed with conventional systems.

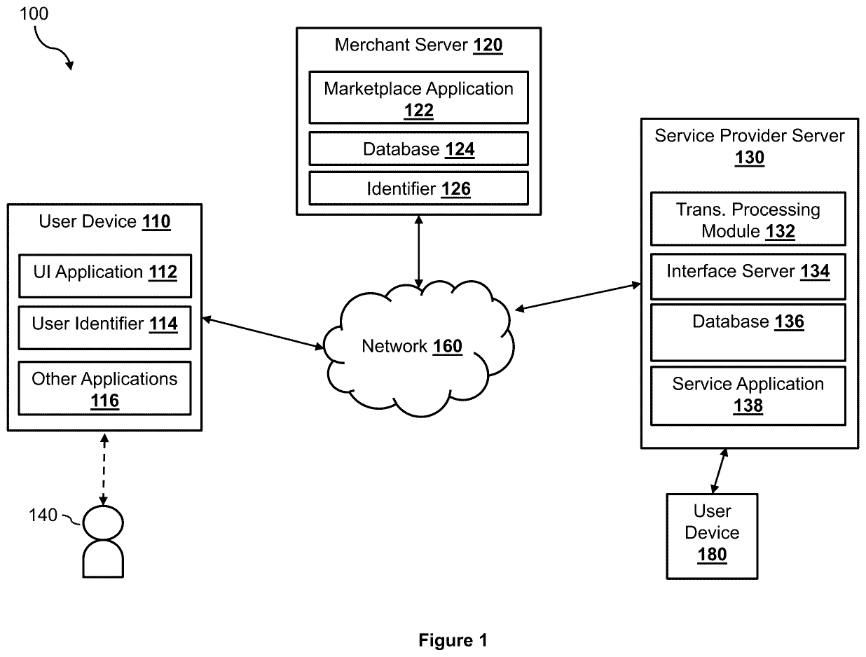

FIG. 1 illustrates an electronic transaction system 100, within which the framework may be implemented according to one embodiment of the disclosure. The electronic transaction system 100 includes a service provider server 130, a merchant server 120, and a user device 110, that may be communicatively coupled with each other via a network 160. The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet.

The user device 110, in one embodiment, may be utilized by a user 140 to interact with the merchant server 120 and/or the service provider server 130 over the network 160. For example, the user 140 may use the user device 110 to conduct an online purchase transaction with the merchant server 120 via websites hosted by, or mobile applications associated with, the merchant server 120 respectively. The user 140 may also log in to a user account to access account services or conduct electronic transactions (e.g., account transfers or payments) with the service provider server 130. The user device 110, in various embodiments, may be implemented using any appropriate combination of hardware and/or software configured for wired and/or wireless communication over the network 160. In various implementations, the user device 110 may include at least one of a wireless cellular phone, wearable computing device, PC, laptop, etc.

The user device 110, in one embodiment, includes a user interface (UI) application 112 (e.g., a web browser, a mobile payment application, etc.), which may be utilized by the user 140 to interact with the merchant server 120 and/or the service provider server 130 over the network 160. In one implementation, the user interface application 112 includes a software program (e.g., a mobile application) that provides a graphical user interface (GUI) for the user 140 to interface and communicate with the service provider server 130 and/or the merchant server 120 via the network 160. In another implementation, the user interface application 112 includes a browser module that provides a network interface to browse information available over the network 160. For example, the user interface application 112 may be implemented, in part, as a web browser to view information available over the network 160. Thus, the user 140 may use the user interface application 112 to initiate electronic transactions with the merchant server 120 and/or the service provider server 130.

The user device 110, in various embodiments, includes other applications 116 as may be desired in one or more embodiments of the present disclosure to provide additional features available to the user 140. In one example, such other applications 116 may include security applications for implementing client-side security features, programmatic client applications for interfacing with appropriate application programming interfaces (APIs) over the network 160, and/or various other types of generally known programs and/or software applications. In still other examples, the other applications 116 may interface with the user interface application 112 for improved efficiency and convenience.

The user device 110, in one embodiment, includes at least one identifier 114, which may be implemented, for example, as operating system registry entries, cookies associated with the user interface application 112, identifiers associated with hardware of the user device 110 (e.g., a media control access (MAC) address), or various other appropriate identifiers. In various implementations, the identifier 114 is passed with a user login request to the service provider server 130 via the network 160, and the identifier 114 may be used by the service provider server 130 to associate the user with a particular user account (e.g., and a particular profile).

In various implementations, the user 140 is able to input data and information into an input component (e.g., a keyboard) of the user device 110. For example, the user 140 may use the input component to interact with the UI application 112 (e.g., to add a new funding account, to perform an electronic purchase transaction with a merchant associated with the merchant server 120, to provide information associated with the new funding account, to initiate an electronic payment transaction with the service provider server 130, to apply for a financial product through the service provider server 130, to access data associated with the service provider server 130, etc.).

It has been contemplated that multiple user devices, each associated with a different user, may be connected to the merchant server 120 and the service provider server 130 via the network 160.

The merchant server 120, in various embodiments, is maintained by a business entity (or in some cases, by a partner of a business entity that processes transactions on behalf of business entity). Examples of business entities include merchants, resource information providers, utility providers, real estate management providers, social networking platforms, etc., which offer various items for purchase and process payments for the purchases. The merchant server 120 may include a merchant database 124 for identifying available items or services, which may be made available to the user device 110 for viewing and purchase by the user.

The merchant server 120, in one embodiment, includes a marketplace application 122, which may be configured to provide information over the network 160 to the user interface application 112 of the user device 110. In one embodiment, the marketplace application 122 includes a web server that hosts a merchant website for the merchant. For example, the user 140 of the user device 110 may interact with the marketplace application 122 through the user interface application 112 over the network 160 to search and view various items or services available for purchase in the merchant database 124. The merchant server 120, in one embodiment, may include at least one merchant identifier 126, which may be included as part of the one or more items or services made available for purchase so that, e.g., particular items are associated with the particular merchants. In one implementation, the merchant identifier 126 includes one or more attributes and/or parameters related to the merchant, such as business and banking information. The merchant identifier 126 may include attributes related to the merchant server 120, such as identification information (e.g., a serial number, a location address, GPS coordinates, a network identification number, etc.).

While only one merchant server 120 is shown in FIG. 1, it has been contemplated that multiple merchant servers, each associated with a different merchant, may be connected to the user device 110 and the service provider server 130 via the network 160.

The service provider server 130, in one embodiment, may be maintained by a transaction processing entity or an online service provider, which may provide processing for electronic transactions between the user 140 of user device 110 and one or more merchants. As such, the service provider server 130 may include a service application 138, which may be adapted to interact with the user device 110 and/or the merchant server 120 over the network 160 to facilitate the electronic transactions (e.g., electronic payment transactions, data access transactions, etc.) among users and merchants processed by the service provider server 130. In one example, the service provider server 130 may be provided by PayPal®, Inc., of San Jose, California, USA, and/or one or more service entities or a respective intermediary that may provide multiple point of sale devices at various locations to facilitate transaction routings between merchants and, for example, service entities.

In some embodiments, the service application 138 may include a payment processing application (not shown) for processing purchases and/or payments for electronic transactions between a user and a merchant or between any two entities. In one implementation, the payment processing application assists with resolving electronic transactions through validation, delivery, and settlement. As such, the payment processing application settles indebtedness between a user and a merchant, wherein accounts may be directly and/or automatically debited and/or credited of monetary funds in a manner as accepted by the banking industry.

The service provider server 130 may also include an interface server 134 that is configured to serve content (e.g., web content) to users and interact with users. For example, the interface server 134 may include a web server configured to serve web content in response to HTTP requests. In another example, the interface server 134 may include an application server configured to interact with a corresponding application (e.g., a service provider mobile application) installed on the user device 110 via one or more protocols (e.g., RESTAPI, SOAP, etc.). As such, the interface server 134 may include pre-generated electronic content ready to be served to users. For example, the interface server 134 may store a log-in page and is configured to serve the log-in page to users for logging into user accounts of the users to access various service provided by the service provider server 130. The interface server 134 may also include other electronic pages associated with the different services (e.g., electronic transaction services, etc.) offered by the service provider server 130. As a result, a user (e.g., the user 140 or a merchant associated with the merchant server 120, etc.) may access a user account associated with the user and access various services offered by the service provider server 130, by generating HTTP requests directed at the service provider server 130.

The service provider server 130, in one embodiment, may be configured to maintain a database 136 that stores data associated with the online service provider, such as user data associated various accounts of users with the online service provider, (e.g., the user 140 associated with user device 110, the merchant associated with the merchant server 120, etc.), transaction data associated transactions conducted between accounts with the online service provider, device data associated with devices used by users to conduct transactions, and various other information collected by the service provider server 130. For example, account information may include private financial information of users and merchants, such as one or more account numbers, passwords, credit card information, banking information, digital wallets used, or other types of financial information, transaction history, Internet Protocol (IP) addresses, device information associated with the user account. In certain embodiments, account information also includes user purchase profile information such as account funding options and payment options associated with the user, payment information, receipts, and other information collected in response to completed funding and/or payment transactions. Transaction information may include transaction amounts, dates, times, and/or locations associated with the transactions, transaction types, items being purchased in the transactions, and other information related to the transactions. Device information may include device identifiers (e.g., MAC addresses, etc.), network addresses (e.g., Internet Protocol (IP) addresses, etc.), screen resolutions, operating system information, device manufacturers and models, and other information related to the devices used to conduct the transactions.

In one implementation, a user may have identity attributes stored with the service provider server 130, and the user may have credentials to authenticate or verify identity with the service provider server 130. User attributes may include personal information, banking information and/or funding sources. In various aspects, the user attributes may be passed to the service provider server 130 as part of a login, search, selection, purchase, and/or payment request, and the user attributes may be utilized by the service provider server 130 to associate the user with one or more particular user accounts maintained by the service provider server 130 and used to determine the authenticity of a request from a user device.

In various embodiments, the service provider server 130 also includes a transaction processing module 132 that implements the computer system or framework as discussed herein. The transaction processing module 132 may be configured to process transaction requests received from the user device 110 and/or the merchant server 120 via the interface server 134. In some embodiments, depending on the type of transaction requests received via the interface server 134 (e.g., a login transaction, a data access transaction, a payment transaction, etc.), the transaction processing module 132 may use different machine learning models to perform different tasks associated with the transaction request. For example, the transaction processing module 132 may use various machine learning models to analyze different aspects of the transaction request (e.g., a fraudulent transaction risk, a chargeback risk, a recommendation based on the request, etc.) based on different input data. The machine learning models may produce outputs that classify a transaction (e.g., a fraudulent transaction, a non-fraudulent transaction, etc.) or indicate an identity of a product or service to be recommended to a user. The transaction processing module 132 may then perform an action for the transaction request based on the outputs. For example, the transaction processing module 132 may determine to authorize the transaction request (e.g., by using the service applications 138 to process a payment transaction, enabling a user to access a user account, etc.) when the transaction is classified as a non-fraudulent transaction, and may deny the transaction request when the transaction is classified as a fraudulent transaction.

As such, the transaction processing module 132 may configure, train, and deploy multiple machine learning models to perform different tasks for assisting in the transaction processing process. When configuring a machine learning model, the transaction processing module 132 needs to determine a set of input features used by the machine learning model. In order to configure and train these machine learning models to perform their respective tasks, the transaction processing module 132 may determine input features for each of the machine learning models. An input feature for a machine learning model refers to a variable type (or an attribute type) corresponding to one of the inputs of the machine learning model. Once input features are defined for the machine learning model, data corresponding to the input features (e.g., variables corresponding to the variable types, attribute values corresponding to the attribute types) may be provided to the machine learning model as input values, that are used by the machine learning model to perform a corresponding task. Since the machine learning model can only use the input data to perform the task, it is critical that the input data provided to the machine learning model is highly relevant to the performance of the task. As such, selecting high quality input features for a machine learning model, a process that is also known as “feature engineering,” is crucial to improving the prediction accuracy performance of a machine learning model.

In some embodiments, the transaction processing module 132 may evaluate (or enable an application executed on a device 180 to evaluate) different feature candidates that can be potentially used as input features for a machine learning model based on the data stored in the database 136. In some embodiments, the device 180 may be operated by a user (e.g., a data scientist, etc.) of the online service provider. To facilitate the evaluation of feature candidates, the transaction processing module 132 may generate, using the data stored in the database 136, a graph that represents various assets (e.g., user accounts, etc.) associated with the online service provider and relationships among the different assets (e.g., transactions conducted among the different user accounts, etc.). The generation of such a graph enables additional feature candidates, that may otherwise not be accessible using only the database 136, to be available to the transaction processing module 132 and/or the application of the device 180. However, as new data types become available and/or shifts in behavior patterns are detected, the transaction processing module 132 and/or the data scientist that operates the application of the device 180 may desire to evaluate additional feature candidates for the machine learning models. The additional feature candidates may not be accessible based on traversing the graph due to the vertex type and/or the edge type available in the graph. In some embodiments, the transaction processing module 132 dynamically generates different merged graphs by combining the graph of the online service provider with different instances of research graphs corresponding to different additional feature candidates to facilitate the accessing and evaluation of different feature candidates in the feature selection process.

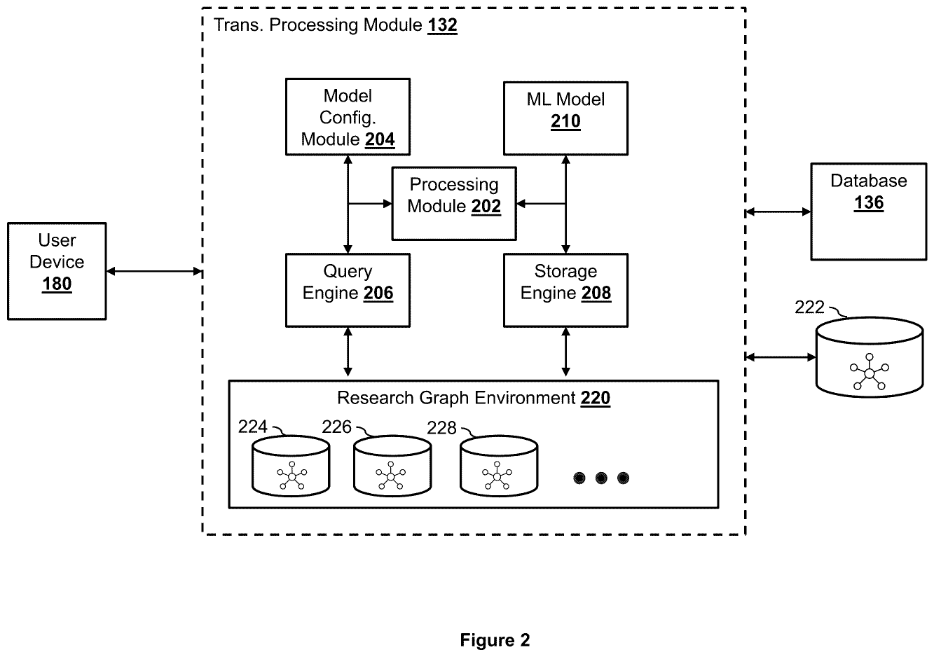

FIG. 2 illustrates the transaction processing module 132 according to various embodiments of the disclosure. The transaction processing module 132 includes a processing module 202, a model configuration module 204, a query engine 206, a storage engine 208, and a machine learning model 210. In some embodiments, the processing module 202 may generate a graph 222 based on data stored in the database 136. To generate the graph 222 for the online service provider, the processing module 202 may first determine a graph schema for the graph 222. The graph schema specifies (or defines) one or more types of vertices and one or more types of edges for the graph 222. The one or more types of vertices (or vertex types) may represent one or more types of assets associated with the online service provider, and the one or more types of edges (or edge types) may represent one or more types of relationships among the assets. For example, the transaction processing module 132 may generate a graph schema that specifies a first type of vertex representing user accounts with the online service provider, and a first type of edges representing transactions conducted among the user accounts. The transaction processing module 132 may then construct the graph 222 (e.g., generating graph data representing different vertices and edges of the graph) based on at least a portion of the underlying data obtained from the database 136. For example, the transaction processing module 132 may analyze the data stored in the database 136. The transaction processing module 132 may retrieve portions of the data that is relevant for constructing the graph 222 according to the graph schema (data that is usable for constructing the vertices and the edges of the graph), and use the portions of the data to generate graph data for the graph 222. The graph data may include vertex data associated with different vertices generated for the graph and edge data associated with different edges generated to connect different vertices in the graph.

When the graph schema specifies a first type of vertex representing user accounts with the organization, the transaction processing module 132 may obtain user account data from the database 136, and generate vertex data based on user account data associated with each user account. When the graph schema specifies a type of edge representing transactions conducted between user accounts, the transaction processing module 132 may obtain transaction data from the database 136, and generate edge data based on transaction data associated with each transaction. The vertex data associated with a vertex may also include identities of one or more edges (e.g., edge identifiers, etc.) that are connected to the vertex in the graph. Similarly, the edge data associated with an edge may also include identities of vertices (e.g., vertex identifiers, etc.) that the edge connect in the graph. Based on the graph data, the transaction processing module 132 may render a visual representation of the graph 222 with vertices connected by edges based on the graph data. The transaction processing module 132 may also access and analyze data corresponding to different feature candidates of a machine learning model by traversing (also referred to as “hopping”) across different vertices in the graph via the edges and accessing different portions of the graph data (e.g., vertex data, edge data, etc.).

In some embodiments, the graph data of the graph 222 is stored in a production environment, similar to the underlying data stored in the database 136. As such, the graph 222 may be updated, along with the underlying data stored in the database 136, based on activities (e.g., transactions) that occur in real-time. By storing the graph data of the graph 222 in the production environment, the transaction processing module 132 may query data from the database 136 and/or the graph 222 to be used by one or more of the machine learning models (e.g., the machine learning model 210) when processing transactions. For example, when the user 140 submits, via the application 112 of the user device 110, a request for processing a transaction (e.g., a login transaction, a payment transaction, a data access transaction, etc.) with the service provider server 130, the transaction processing module 132 may process the transaction using the techniques disclosed herein. The processing module 202 may use one or more machine learning models (e.g., the machine learning model 210) to classify the transaction (e.g., determining whether the transaction is a legitimate transaction or a fraudulent transaction, etc.). Specifically, the processing module 202 may determine input data for the one or more machine learning models by accessing user data associated with the user account of the user 140, transaction data associated with past transactions conducted through the user account, and other data from the database 136 and the graph 222. Each of the one or more machine learning models is configured to generate an output based on the input data. Based on one or more outputs from the one or more machine learning models, the processing module 202 may process the transaction (e.g., authorize the transaction using the service application 138, deny the transaction, etc.). After processing the transaction for the user 140, the transaction processing module 132 may also update one or more records in the database 136 and the graph data associated with the graph 222 (e.g., adding a transaction record in the database 136, adding an edge between a vertex representing the user account of the user 140 and another vertex representing the user account of a counterparty of the transaction in the graph 222, etc.).

Each of the machine learning models (e.g., the machine learning model 210) may be configured to accept a set of input values corresponding to a set of input features for performing the corresponding prediction tasks (e.g., classifying a transaction as a fraudulent transaction or a legitimate transaction, predicting a product associated with a purchase transaction, etc.). The set of input features determined for each of the machine learning models dictates the type of data that is available for the machine learning model to perform the task. As such, the quality of the input features (e.g., how relevant are the input features in performing the task) is a major factor to the accuracy performance of the machine learning model.

In some embodiments, the model configuration module 204 generates, configures, and trains the machine learning models that can be used by the processing module 202 for processing transactions. Each of the machine learning models may be configured to perform a specific task (e.g., determining whether a transaction is a potential account take-over transaction, determining whether a transaction is a fraudulent charge-back transaction, determining whether a user is interested in a particular product, etc.). The model configuration module 204 may determine a set of input features that is relevant for the performance of a corresponding task for each of the machine learning models (e.g., based on inputs received by a data scientist via the user device 180, based on analyzing the data in the database 136, etc.). For example, for a machine learning model that is configured to determine whether a transaction is a fraudulent transaction, the model configuration module 204 may determine a set of input features including a transaction amount, a transaction type, a network address associated with a device that initiates the transaction, a transaction history associated with a user account, and so forth. However, it is a challenge to accurately determine which input features are relevant (and which input features are not relevant, and possibly detrimental) to the performance of a specific task.

Typically, the model configuration module 204 (or the user of the user device 180 via an application on the user device 180) may identify possible input features (also referred to as “feature candidates”) for a machine learning model, and may evaluate the feature candidates by querying transaction data from the database 136 and the graph 222. The transaction data that is queried from the database 136 and the graph 222 may include data that corresponds to a feature candidate and other data. The model configuration module 204 (or the user of the user device 180 via an application on the user device 180) may then evaluate the feature candidate based on a correlation between the data corresponding to the feature candidate and outcomes associated with the task (e.g., classifications of the transactions, etc.). The model configuration module 204 may determine to use the feature candidate as one of the input features for the machine learning model if the correlation between the feature candidate and the outcomes exceeds a threshold.

By storing data associated with the online service provider in a graph structure such as the graph 222, additional feature candidates (that may not be readily available when the data is stored in a different data structure such as the database 136) may become available for configuring various machine learning models for performing different tasks. Using the example illustrated above where the graph 222 includes edges that represents transactions conducted among user accounts, the graph 222 enables various input features, such as a volume and a frequency of transactions conducted between specific user accounts since data corresponding to such input features can be readily accessed by traversing the graph 222.

A larger number of feature candidates that are available to the model configuration module 204 (or the user via the user device 180) may allow the model configuration module 204 to determine higher quality input features for a machine learning model, which in turn, translates to a higher accuracy performance for the machine learning model. It has been contemplated that some of the feature candidates that the model configuration module 204 (or the user of the user device 180) desires to evaluate may not be accessible (e.g., missing) from the database 136 or the graph 222. For example, the model configuration module 204 may desire to evaluate a feature candidate representing a number of user accounts that share the same device used in a transaction, which is not available in the graph 222 according to the current graph schema, and which is difficult to access in the underlying data in the database 136.

In some embodiments, when the model configuration module 204 (or the user of the user device 180) indicates a desire to access and evaluate a feature candidate that is not accessible from the database 136 or the graph 222, the processing module 202 may use the techniques disclosed herein to provide the model configuration module 204 (or the user of the user device 180) access to the feature candidate without modifying the graph 222. Specifically, the processing module 202 may generate a new graph schema by modifying the existing graph schema associated with the graph 222. For example, the computer system may generate the new graph schema based on adding one or more vertex types and/or one or more edge types. Using the example illustrated above where the original graph schema of the graph 222 only includes a vertex type representing user accounts and an edge type representing transactions conducted among user accounts, the processing module 202 may determine that the feature candidate (e.g., a feature representing a number of user accounts sharing the same user device, etc.) requires a new vertex type and/or a new edge type. As such, the processing module 202 may generate a new graph schema (which may be a temporary graph schema generated for the purpose of evaluating the feature candidate) based on the feature candidate. For example, the processing module 202 may generate the new graph schema by adding, to the existing graph schema, a new vertex type representing user devices and a new edge type representing a usage of user devices in transactions conducted through user accounts.

In some embodiments, instead of modifying the graph data of the original graph 222 based on the new graph schema, the processing module 202 generates sperate graph data (e.g., graph data 224) for the new graph schema. The graph data 224 is separate from the existing graph data for the original graph 222, and includes only graph data that is different (e.g., missing from) the original graph 222 based on the new graph schema. For example, the new graph data 224 may include vertex data associated with vertices that represent various user devices used to conduct transactions with the organization, and edge data associated with edges that represent usage of the user devices in the transactions conducted through various user accounts. The processing module 202 may obtain the new vertex data and the new edge data by traversing and analyzing the underlying data stored in the database 136 of the online service provider, and retrieve portions of the data that are related to the new vertices and the new edges. In some embodiments, the new graph data 224 does not include any of the graph data that exists in the original graph 222. Since the new graph data 224 only includes vertex data and edge data associated with the new vertex type and/or the new edge type specified in the modified graph schema, the new graph data 224 may be insufficient for rendering a graph by itself, but may be combined with the original graph data to generate a merged graph. In some embodiments, the storage engine 208 may store the new graph data 224 in an environment (e.g., a research environment 220, etc.) separate from the production environment within which the original graph data resides. As such, while the original graph data may be updated based on activities performed (e.g., transactions conducted, etc.) in real-time, the new graph data 224 may not be updated after it is generated to ensure that the evaluation of the new feature candidate is consistent.

Once the new graph data 224 is generated, the processing module 202 may enable other applications or modules (e.g., the model configuration module 204, an application of the user device 180, etc.) to query data from the graph 222 according to the modified graph schema as if the original graph 222 has been modified based on the modified graph schema. For example, the processing module 202 may provide the new graph schema to the model configuration module 204 and the application of the user device 180 such that the model configuration module 204 and the application may query the graph 222 based on the new graph schema.

When the query engine 206 receives a query against the graph 222 from the model configuration module 204 or the application of the user device 180, the query engine 206 may determine whether the query requires data corresponding to the new feature candidate (data corresponding to the vertex type(s) and/or the edge type(s) that are not included in the original graph schema, but included in the new graph schema). If the query requires data corresponding to the new feature candidate, instead of executing the query directly against the graph 222, the query engine 206 may generate a merged graph by combining the original graph 222 and the new graph data 224. The merged graph will include vertices and edges according to the modified graph schema (which includes the vertices and edges from the original graph 222 and the vertices and edges from the new graph data 224). The query engine 206 may then execute the query against the merged graph and generate a response to the query using data obtained and/or derived from the merged graph. As such, based on the use of the query engine 206, the processing module 202 provides the other applications an illusion that the graph 222 has been modified according to the modified graph schema when the graph 222 is in fact not modified. Such a technique enables the model configuration module 204 (or the application of the user device 180) to query data based on the modified graph schema, which allows the model configuration module 204 (or the application of the user device 180) to evaluate the new feature candidate (e.g., determining a correlation between data corresponding to the new feature candidate the outcomes of the transactions, etc.) in an efficient manner.

In some embodiments, the processing module 202 may enable the model configuration module 204 (or the application of the user device 180) to evaluate multiple feature candidates. For example, if it is determined that multiple feature candidates that the model configuration module 204 (or the user of the user device 180) wishes to evaluate cannot be accessed from the existing database 136 or the graph 222, the processing module 202 may generate multiple new graph schemas based on the graph schema of the graph 222, where each new graph schema is generated to include data corresponding to a new feature candidate. The processing module 202 may also generate new graph data (e.g., new graph data 226 and 228) based on the new graph schemas. The storage engine 208 may store the new graph data 224, 226, and 228 in the research graph environment 220, where each of the new graph data 224, 226, and 228 can be independently accessed. When the query engine 206 receives a query against the graph 222 from the model configuration module 204 or the application of the user device 180, the query engine 206 may determine whether the query requires data corresponding to any one of the new feature candidates (data corresponding to the vertex type(s) and/or the edge type(s) that are not included in the original graph schema, but included in one of the new graph schemas). If the query requires data corresponding to one or more new feature candidates, the query engine 206 may generate a merged graph by combining the original graph 222 with one or more of the new graph data corresponding to the new feature candidate(s). The query engine 206 may execute the query against the merged graph and generate a response to the query using data obtained and/or derived from the merged graph. By enabling the model configuration module 204 (or the application of the user device 180) to dynamically query data based on different modified graph schemas, the model configuration module 204 (or the application of the user device 180) may evaluate and compare different new feature candidates (e.g., determining which new feature has a highest correlation with the outcomes of the transactions, etc.).

By generating and storing the new graph data 224, 226, and 228 separately from the graph 222, the processing module 202 enables the new graph data to be independently created, modified, and deleted without affecting the graph 222, while providing users (e.g., the model configuration module 204, the user of the user device 180, etc.) access to data corresponding to the feature candidates. For example, when the model configuration module 204 or the user of the user device 180 determines not to use one of the feature candidates after the evaluation, the storage engine 208 may remove the corresponding modified graph schema and graph data from the research graph environment 220. Since the graph 222 was never modified to accommodate the access of the new feature candidate, no modification needs to be performed on the graph 222, which eliminates any complexities from modifying the graph 222 in the production environment.

On the other hand, if the model configuration module 204 or the user of the user device 180 determines to use one of the feature candidates in a machine learning model (e.g., the machine learning model 210), the processing module 202 may then modify the graph 222 by merging the new graph data (e.g., the new graph data 222) with the graph data of the graph 222, such that the machine learning model 210 can be configured with the new input feature. The model configuration module 204 may also modify and/or re-configure the machine learning model 210 such that the machine learning model 210 may accept data corresponding to the feature candidate as input data for performing the task. In some embodiments, the model configuration module 204 also generates new training data for the machine learning model 210 by querying the database 136 and/or the graph 222, and re-trains the machine learning model 210 using the new training data.

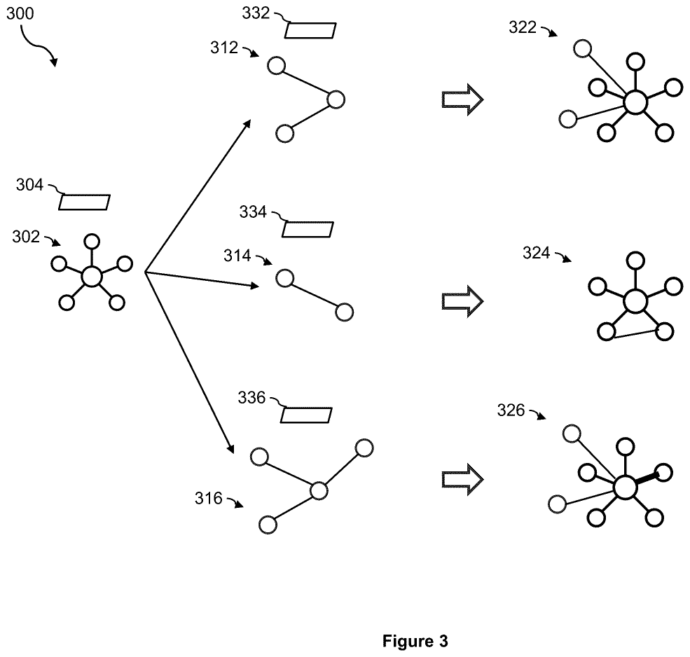

FIG. 3 illustrates examples 300 of merging graphs according to various embodiments of the disclosure. As shown in FIG. 3, graph data associated with a graph 302 is a production graph associated with the online service provider, which may correspond to the graph 202 in FIG. 2. The graph 302 may be generated based on a graph schema 304 that defines the types of vertices and edges available for the graph 302. Graph data 312, 314, and 316 may correspond to the graph data 224, 226, and 228 in FIG. 2, respectively, and may be generated based on requests to evaluate certain feature candidates for one or more machine learning models. Each of the graph data 312, 314, and 316 may be generated based on a modified graph schema. A modified graph schema may be generated by modifying the graph schema of the graph 302, for example, by adding at least one of an additional vertex type and/or an edge type, by changing the definition of an existing vertex type or an existing edge type, etc.

Specifically, the graph data 312 may be generated based on a modified graph schema 332 that adds an additional vertex type and an additional edge type to the graph schema 304 of the graph 302. As such, the graph data 312 may include data obtained from the database 136 that corresponds to the additional vertex type and the additional edge type (e.g., additional vertices and additional edges for the graph 302). When a query associated with the modified graph schema 332 is received via an interface of the transaction processing module 132, the query engine 206 may merge the graph data 312 with the graph 302 to generate a merged graph 322. As shown, the merged graph 322 adds, to the graph 302, additional vertices that connect to an existing vertex in the graph 302 via additional edges based on the additional vertex type and the additional edge type indicated in the modified graph schema 332.

The graph data 314 may be generated based on a modified graph schema 334 that adds only an additional edge type to the graph schema 304 of the graph 302. As such, the graph data 314 may include data obtained from the database 136 that corresponds to the additional edge type (e.g., additional edges for the graph 302). When a query associated with the modified graph schema 334 is received via an interface of the transaction processing module 132, the query engine 206 may merge the graph data 314 with the graph 302 to generate a merged graph 324. As shown, the merged graph 324 adds an additional edge that connects two existing vertices in the graph 302 based on the additional edge type indicated in the modified graph schema 332.

The graph data 316 may be generated based on a modified graph schema 336 that adds an additional vertex type and multiple additional edge types to the graph schema 304 of the graph 302. As such, the graph data 316 may include data obtained from the database 136 that corresponds to the additional vertex type and the additional edge types (e.g., additional vertices and additional edges for the graph 302). When a query associated with the modified graph schema 336 is received via an interface of the transaction processing module 132, the query engine 206 may merge the graph data 316 with the graph 302 to generate a merged graph 326. As shown, the merged graph 326 adds, to the graph 302, additional new vertices that connect to an existing vertex via new edges and a new edge that connects two existing vertices (as indicated as a thicker line that connects two existing vertices) in the graph 302 based on the additional vertex type and the additional edge type indicated in the modified graph schema 332.

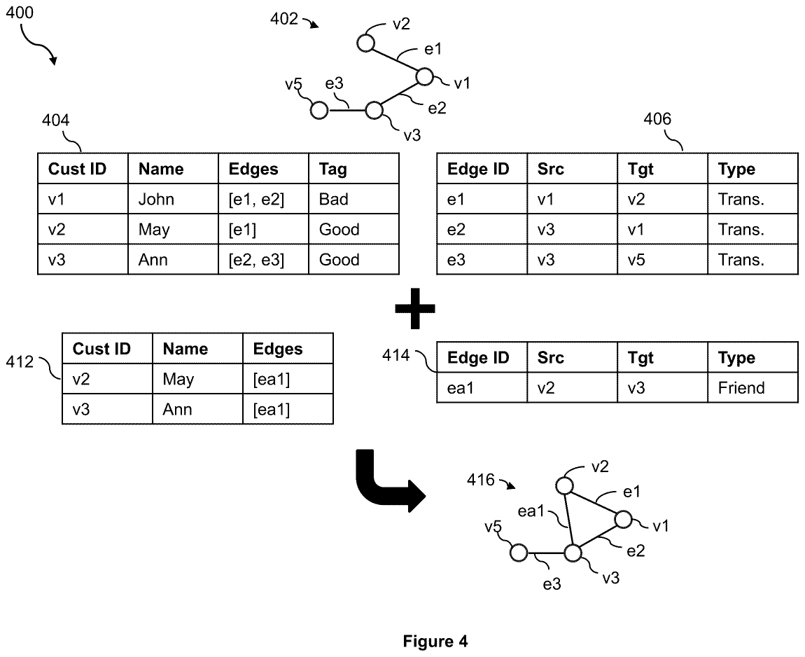

FIG. 4 illustrates an example 400 of merging graph data into an existing graph 402 according to various embodiments of the disclosure. In this example, the graph 402 is generated for the online service provider based on a graph schema that specifies a vertex type associated with user accounts and an edge type associated with transactions conducted among user accounts. The graph 402 includes vertex data 404 and edge data 406, which can be used to render a graphical representation of the graph 402. The vertex data 404 includes data associated with the vertices in the graph 402. In this example, the vertex data 404 indicates that the graph 402 includes three vertices—Vertex ‘v1,’ Vertex ‘v2,’ and Vertex ‘v3.’ As shown, each of the vertices represents a different user account. The vertex data 404 also links additional information associated with a user account to each vertex. In this example, Vertex ‘v1’ represents a user account associated with a user “John.” The vertex data 404 also shows that Vertex ‘v1’ is connected to other vertices via Edges 'e1′ and ‘e2,’ and that the user account of John has a “bad” tag (indicating that the user account is associated with suspicious behavior). The vertex data 404 also shows that Vertex ‘v2’ represents another user account associated with a user “May,” that Vertex ‘v2’ connects to another vertex via Edge ‘e1,’ and that the user account associated with May has a “good” tag (indicating that the user account is not associated with suspicious behavior). The vertex data 404 also shows that Vertex ‘v3’ represents another user account associated with a user “Ann,” that Vertex ‘v3’ connects to other vertices via Edges ‘e2’ and ‘e3’ and that the user account associated with Ann has a “good” tag (indicating that the user account is not associated with suspicious behavior).

The edge data 406 includes data associated with the edges in the graph 402. In this example, the edge data 406 indicates that the graph 402 includes three edges - Edge ‘e1,’ Edge ‘e2,’ and Edge ‘e3.’ Each of the three edges represents a transaction conducted between two user accounts. For example, the edge data 406 indicates that Edge ‘e1’ represents a transaction conducted between user accounts represented by Vertex ‘v1’ and Vertex ‘v2’ (e.g., the user account represented by Vertex ‘v1’ sends funds to the user account represented by Vertex ‘v2’). The edge data 406 also indicates that Edge ‘e2’ represents a transaction conducted between user accounts represented by Vertex ‘v3’ and Vertex ‘v1’ (e.g., the user account represented by Vertex ‘v3’ sends funds to the user account represented by Vertex ‘v1’). The edge data 406 also indicates that Edge ‘e3’ represents a transaction conducted between user accounts represented by Vertex ‘v3’ and Vertex ‘v5’ (e.g., the user account represented by Vertex ‘v3’ sends funds to the user account represented by Vertex ‘v1’).

FIG. 4 also shows new graph data that is generated based on a modified graph schema. In this example, the modified graph schema specifies an additional edge type to the graph schema of the graph 402. The additional edge type represents a friendship relationship among user accounts. The new graph includes vertex data 412 and edge data 414 that is generated based on the additional edge type included in the modified graph schema. In some embodiments, the vertex data 412 and the edge data 414 only includes data that is not included in the vertex data 404 and the edge data 406. For example, the vertex data 412 indicates that both Vertex ‘v2’ and Vertex ‘v3’ are connected via a new Edge ‘ea1,’ and the edge data 414 includes information related to the new Edge ‘ea1’ connects Vertex ‘v2 and Vertex ‘v3,’ indicating that the users of the user accounts represented by Vertex ‘v2’ and Vertex ‘v3’ are friends.

When a query associated with the modified graph schema is received, the query engine 206 may generate a merged graph 416 by merging the vertex data 412 and edge data 414 into the graph 402. For example, the query engine 206 may incorporate the new Edge ‘ea1’ into the graph 402 to generate the merged graph 416. The query engine 206 may then process the query based on the merged graph 416. The query engine 206 may produce a result (e.g., queried data) based on querying the merged graph 415, and provide the result to the requester (e.g., the model configuration module 204, the application of the user device 180, etc.).

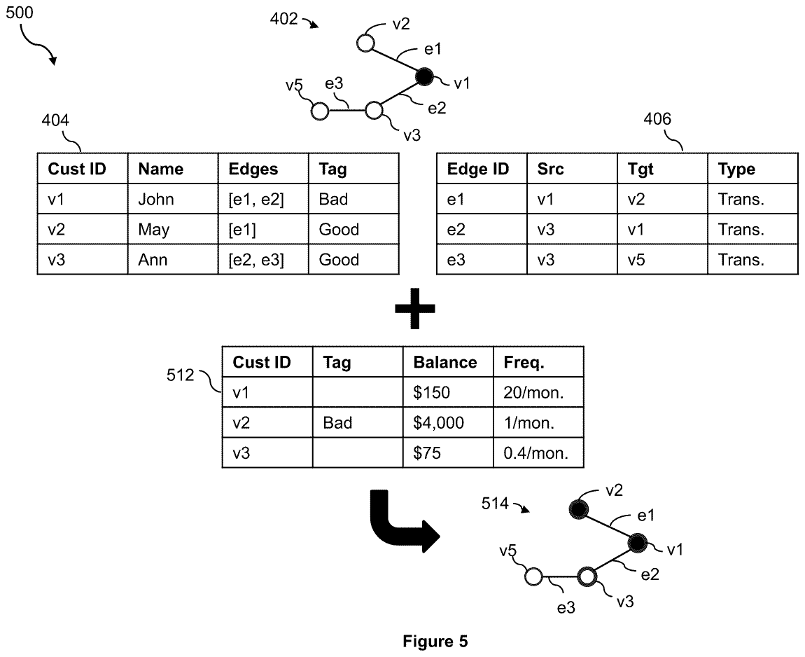

FIG. 5 illustrates another example 500 of merging graph data into the existing graph 402 according to various embodiments of the disclosure. The graph 402 is associated with vertex data 404 and edge data 406. As discussed above, the vertex data 404 includes information related to each vertex, such as a name associated with a user account represented by a corresponding vertex, one or more edges connected to the vertex, and a tag associated with the user account represented by the vertex. The graph 402 also shows that Vertex ‘v2’ and Vertex ‘v3’ are associated with a “good” tag, as indicated by the hollow rendering of the vertices in the graph 402. On the other hand, Vertex ‘v1’ is associated with a “bad” tag, as indicated by the solid rendering of the vertex in the graph 402.

It has been contemplated that, instead of, or in addition to, adding vertex types or adding edge types to an existing graph schema, the transaction processing module 132 may also modify vertex data and/or edge data in an existing graph to support a new feature (or a new feature candidate). In this example, the transaction processing module 132 may modify the graph schema of the graph 402 by adding additional information (e.g., transaction frequency) regarding each vertex (or the user account represented by each vertex). The processing module 202 may generate new vertex data 512 based on the modified graph schema using data obtained from the database 136. As shown, the new vertex data includes a transaction frequency for each of the vertices in the graph 402. Specifically, the vertex data 512 indicates that the user account represented by Vertex ‘v1’ conducts around twenty transactions per month, the user account represented by Vertex ‘v2’ conducts around 1 transaction per month, and the user account represented by Vertex ‘v3’ conducts around 0.4 transactions per month.

In addition, the modified graph schema generated by the processing module 202 may also specify a different criterion for assigning tags to various user accounts (e.g., a different threshold value, a different algorithm, etc.). In this example, based on the new criterion, the user account represented by Vertex ‘v2’ is now assigned a “bad” tag (instead of a “good” tag as indicated in the graph 402) as indicated in the vertex data 512.

When a query associated with the modified graph schema is received, the query engine 206 may generate a merged graph 514 by merging the vertex data 512 into the graph 402. For example, the query engine 206 may incorporate additional data (e.g., the transaction frequency data) into each vertex of the graph 402, as indicated by the thicker border of each of the vertices (noted that the border of Vertex ‘v3’ is shown to be thicker while the borders of Vertex ‘v1’ and Vertex ‘v2’ are also rendered to be thicker, they have been obscured by the solid rendering of the vertices) in the graph 514. In addition, the new tag assigned to Vertex ‘v2’ is also changed from a “good” tag to a “bad” tag, as indicated by a solid rendering of Vertex ‘v2’ in the graph 514. The query engine 206 may then process the query based on the merged graph 514. The query engine 206 may produce a result (e.g., queried data) based on querying the merged graph 514, and provide the result to the requester (e.g., the model configuration module 204, the application of the user device 180, etc.).

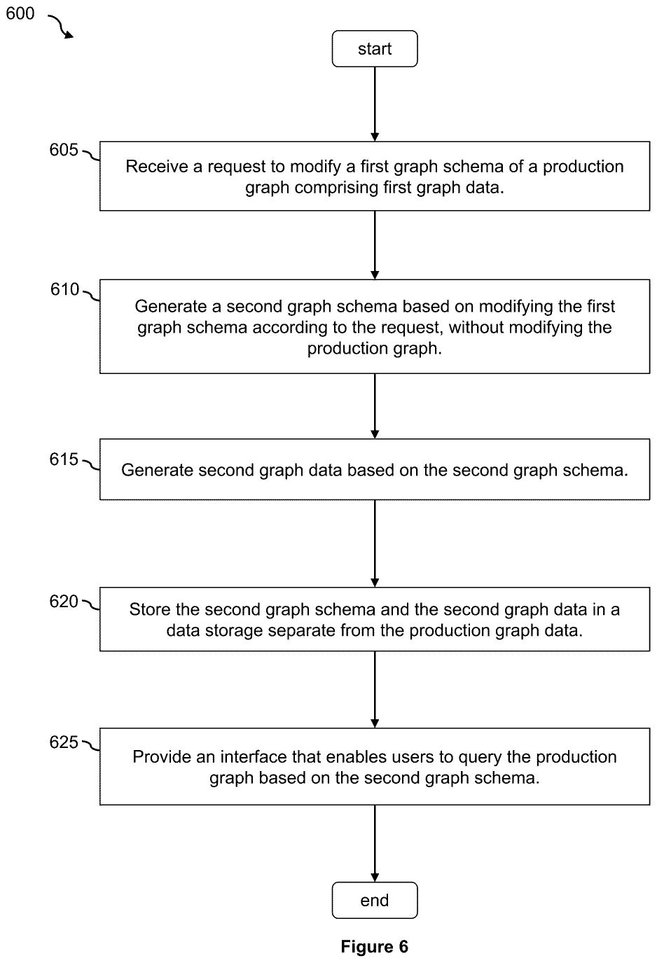

FIG. 6 illustrates a process 600 for enabling access to data corresponding to various features according to various embodiments of the disclosure. In some embodiments, at least a portion of the process 600 may be performed by the transaction processing module 132. The process 600 begins by receiving (at step 605) a request to modify a first graph schema of a production graph comprising first graph data. For example, the model configuration module 204 or a user of the user device 180 (via an application of the user device 180) may submit a request to access data corresponding to a feature candidate for a machine learning model. The processing module 202 may determine that the data corresponding to the feature candidate is not accessible from the database 136 or an existing graph (e.g., the graph 222) generated for the online service provider.

As such, the processing module 202 may enable access to the data corresponding to the feature candidate by generating (at step 610) a second graph schema based on modifying the first graph schema according to the request, without modifying the production graph. The processing module 202 may generate the second graph schema by adding one or more vertex types and/or one or more edge types to the first graph schema. The processing module 202 may also generate the second graph schema by adding information types included in each vertex or each edge, or by modifying a criterion for generating the data (e.g., a tag, a label, etc.) included in each vertex or each edge.

The processing module 202 then generates (at step 615) second graph data based on the second graph schema and stores (at step 620) the second graph schema and the second graph data in a data storage separate from the production graph data. For example, the processing module 202 may generate the second graph data (e.g., the graph data 224, 226, 228, 312, 314, 316, etc.) based on the second graph schema using data obtained from the database 136. The storage engine 208 may then store the second graph schema and the second graph data in the research graph environment 220 that is separate from the production environment that stores the database 136 and the graph 222.

Once the new graph data is generated and stored, the processing module 202 provides (at step 625) an interface (e.g., a user interface, an application programming interface, etc.) that enables users (e.g., the model configuration module 204, the user of the user device 180, etc.) to query the product graph based on the second graph schema.

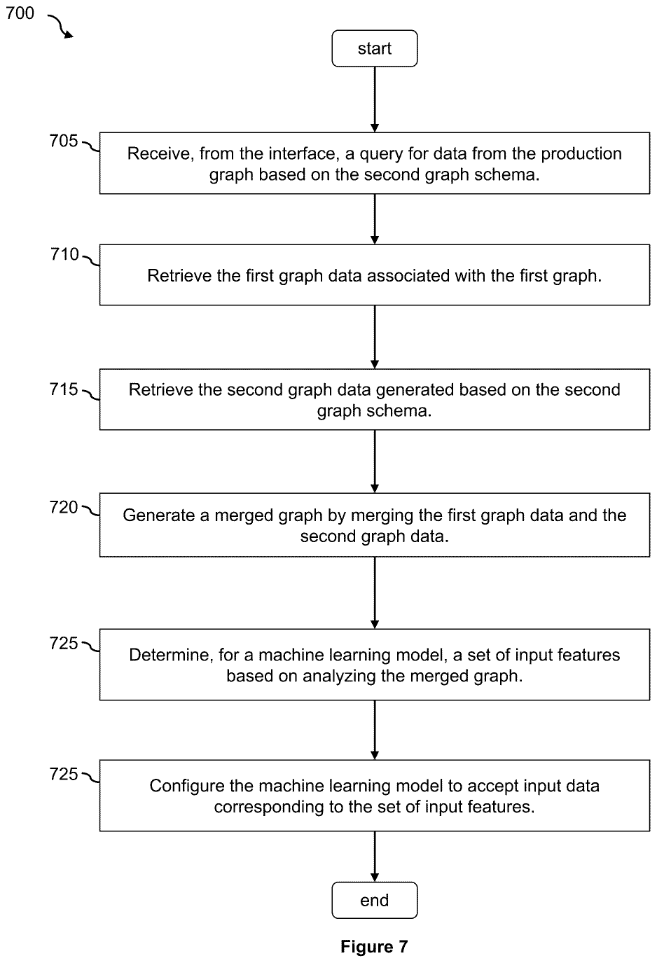

FIG. 7 illustrates a process 700 for processing a query based on a modified graph schema according to various embodiments of the disclosure. In some embodiments, at least a portion of the process 700 may be performed by the transaction processing module 132. The process 700 begins by receiving (at step 705), from the interface, a query for data from the production graph based on the second graph schema. For example, the processing module 202 may receive a query from the model configuration module 204 or the user of the user device 180, as part of a process to evaluate one or more feature candidates for a machine learning model. Upon receiving the query, the processing module 202 retrieves (at step 710) the first graph data associated with the first graph and retrieves (at step 715) the second graph data generated based on the second graph schema. The processing module 202 then generates (at step 720) a merged graph by merging the first graph data and the second graph data. For example, if the second graph data includes data corresponding to an additional vertex and/or an additional edge, the processing module 202 may add one or more vertices and/or one or more edges to the first graph (e.g., the graph 222) based on the second graph data.

After generating the merged graph, the processing module 202 may query the merged graph based on query requests received from another module and/or application. The processing module 202 may obtain results from querying the merged graph and provide the results to the requesting module and/or application. In some embodiments, the model configuration module 204 and/or the application of the user device 180 may evaluate different feature candidates for a machine learning model based on the results obtained from querying the merged graph. Based on the evaluation, the model configuration module 204 and/or the application of the user device 180 determines (at step 725), for the machine learning model, a set of input features and configures (at step 730) the machine learning model to accept input data corresponding to the set of input features.

After configuring and training the machine learning model (e.g., the machine learning model 210), the transaction processing module 132 may deploy the machine learning model 210 for use as part of processing incoming transactions. For example, when a transaction request is received from a user device (e.g., the user device 110), the transaction processing module 132 may access data associated with the transaction request and corresponding to the set of input features (e.g., from the database 136 and the graph 222). The transaction processing module 132 may provide the data to the machine learning model 210 and obtain an output. The transaction processing module 132 may then process the transaction request based on the output. For example, if the output indicates that the transaction is a fraudulent transaction, the transaction processing module 132 may deny the transaction request. On the other hand, if the output indicates that the transaction is a legitimate transaction, the transaction processing module 132 may authorize the transaction request, and uses the service application 138 to further process a transaction based on the transaction request.

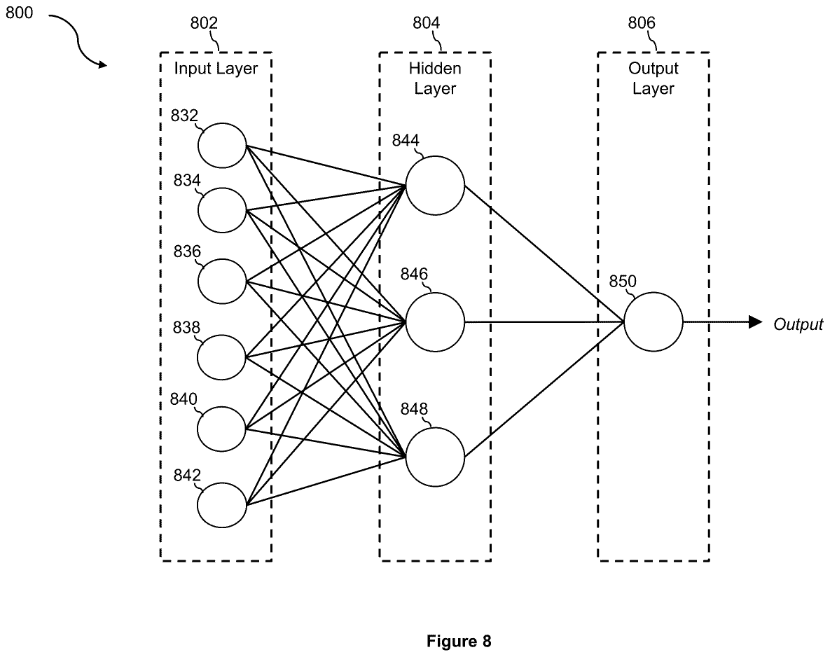

FIG. 8 illustrates an example artificial neural network 800 that may be used to implement any machine learning models (e.g., the machine learning model 210, etc.). As shown, the artificial neural network 800 includes three layers - an input layer 802, a hidden layer 804, and an output layer 806. Each of the layers 802, 804, and 806 may include one or more nodes. For example, the input layer 802 includes nodes 832, 834, 836, 838, 840, and 842, the hidden layer 804 includes nodes 844, 846, and 848, and the output layer 806 includes a node 850. In this example, each node in a layer is connected to every node in an adjacent layer. For example, the node 832 in the input layer 802 is connected to all of the nodes 844, 846, and 848 in the hidden layer 804. Similarly, the node 844 in the hidden layer is connected to all of the nodes 832, 834, 836, 838, 840, and 842 in the input layer 802 and the node 850 in the output layer 806. Although only one hidden layer is shown for the artificial neural network 800, it has been contemplated that the artificial neural network 800 used to implement any one of the computer-based models may include as many hidden layers as necessary.

In this example, the artificial neural network 800 receives a set of inputs and produces an output. Each node in the input layer 802 may correspond to a distinct input. For example, when the artificial neural network 800 is used to implement the machine learning model configured to classify transactions, each node in the input layer 802 may correspond to an input feature (determined using the techniques disclosed herein) associated with classifying a transaction into a fraudulent transaction or a non-fraudulent transaction.

In some embodiments, each of the nodes 844, 846, and 848 in the hidden layer 804 generates a representation, which may include a mathematical computation (or algorithm) that produces a value based on the input values received from the nodes 832, 834, 836, 838, 840, and 842. The mathematical computation may include assigning different weights (e.g., node weights, etc.) to each of the data values received from the nodes 832, 834, 836, 838, 840, and 842. The nodes 844, 846, and 848 may include different algorithms and/or different weights assigned to the data variables from the nodes 832, 834, 836, 838, 840, and 842 such that each of the nodes 844, 846, and 848 may produce a different value based on the same input values received from the nodes 832, 834, 836, 838, 840, and 842. In some embodiments, the weights that are initially assigned to the input values for each of the nodes 844, 846, and 848 may be randomly generated (e.g., using a computer randomizer). The values generated by the nodes 844, 846, and 848 may be used by the node 850 in the output layer 806 to produce an output value for the artificial neural network 800. When the artificial neural network 800 is used to implement the machine learning model configured to classify transactions, the output value produced by the artificial neural network 800 may indicate a classification (e.g., a classification score).

The artificial neural network 800 may be trained by using training data and one or more loss functions (also referred to as “objective functions” herein). By providing training data to the artificial neural network 800, the nodes 844, 846, and 848 in the hidden layer 804 may be trained (adjusted) based on the one or more loss functions such that an optimal output is produced in the output layer 806 to minimize the loss in the loss functions. By continuously providing different sets of training data, and penalizing the artificial neural network 800 when the output of the artificial neural network 800 is incorrect (as defined by the loss functions, etc.), the artificial neural network 800 (and specifically, the representations of the nodes in the hidden layer 804) may be trained (adjusted) to improve its performance in the respective tasks. Adjusting the artificial neural network 800 may include adjusting the weights associated with each node in the hidden layer 804.

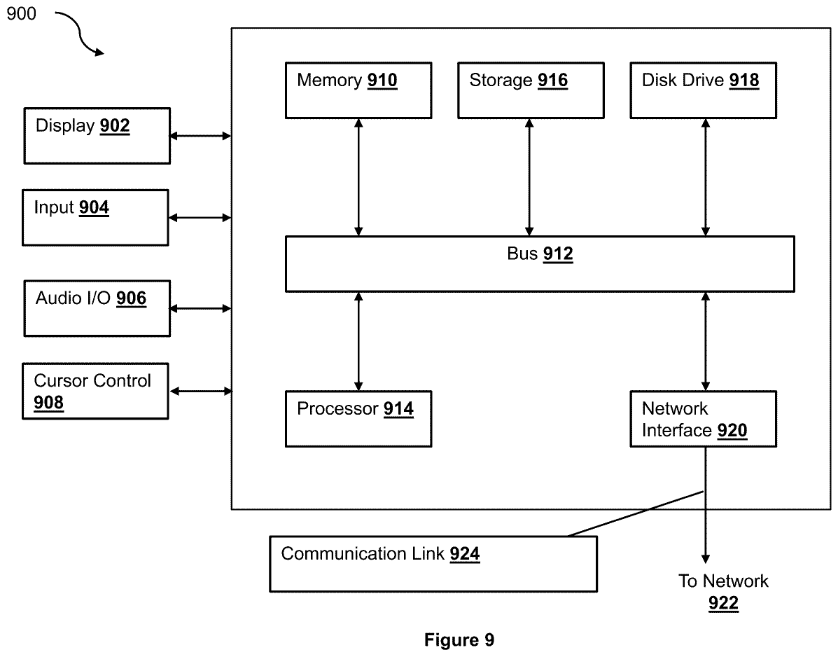

FIG. 9 is a block diagram of a computer system 900 suitable for implementing one or more embodiments of the present disclosure, including the service provider server 130, the merchant server 120, and the user devices 110 and 180. In various implementations, each of the user devices 110 and 180 may include a mobile cellular phone, personal computer (PC), laptop, wearable computing device, etc. adapted for wireless communication, and each of the service provider server 130 and the merchant server 120 may include a network computing device, such as a server. Thus, it should be appreciated that the devices 110, 120, 130, and 180 may be implemented as the computer system 900 in a manner as follows.

The computer system 900 includes a bus 912 or other communication mechanism for communicating information data, signals, and information between various components of the computer system 900. The components include an input/output (I/O) component 904 that processes a user (i.e., sender, recipient, service provider) action, such as selecting keys from a keypad/keyboard, selecting one or more buttons or links, etc., and sends a corresponding signal to the bus 912. The I/O component 604 may also include an output component, such as a display 902 and a cursor control 908 (such as a keyboard, keypad, mouse, etc.). The display 902 may be configured to present a login page for logging into a user account or a checkout page for purchasing an item from a merchant. An optional audio input/output component 906 may also be included to allow a user to use voice for inputting information by converting audio signals. The audio I/O component 906 may allow the user to hear audio. A transceiver or network interface 920 transmits and receives signals between the computer system 900 and other devices, such as another user device, a merchant server, or a service provider server via a network 922. In one embodiment, the transmission is wireless, although other transmission mediums and methods may also be suitable. A processor 914, which can be a micro-controller, digital signal processor (DSP), or other processing component, processes these various signals, such as for display on the computer system 900 or transmission to other devices via a communication link 924. The processor 914 may also control transmission of information, such as cookies or IP addresses, to other devices.

The components of the computer system 900 also include a system memory component 910 (e.g., RAM), a static storage component 916 (e.g., ROM), and/or a disk drive 918 (e.g., a solid-state drive, a hard drive). The computer system 900 performs specific operations by the processor 914 and other components by executing one or more sequences of instructions contained in the system memory component 910. For example, the processor 914 can perform the machine learning model configuration functionalities described herein, for example, according to the processes 600 and 700.

Logic may be encoded in a computer readable medium, which may refer to any medium that participates in providing instructions to the processor 914 for execution. Such a medium may take many forms, including but not limited to, non-volatile media, volatile media, and transmission media. In various implementations, non-volatile media includes optical or magnetic disks, volatile media includes dynamic memory, such as the system memory component 910, and transmission media includes coaxial cables, copper wire, and fiber optics, including wires that comprise the bus 912. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by the computer system 900. In various other embodiments of the present disclosure, a plurality of computer systems 900 coupled by the communication link 924 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system comprising:
a non-transitory memory; and
one or more hardware processors coupled with the non-transitory memory and configured to execute instructions from the non-transitory memory to cause the system to:
access first graph data of a first graph representing relationships among a plurality of assets associated with a service provider, wherein the first graph is associated with a first graph schema that defines one or more vertex types and one or more edge types, and wherein the first graph comprises a plurality of vertices corresponding to the one or more vertex types and a plurality of edges corresponding to the one or more edge types;
receive, from a device, a request for modifying the first graph based on a first change to the first graph schema, wherein the request specifies at least one of an additional vertex type or an additional edge type;
without modifying the first graph, generate (i) a second graph schema based on modifying the first graph schema to include the at least one of the additional vertex type or the additional edge type and (ii) second graph data comprising at least one of an additional vertex or an additional edge corresponding to the second graph schema;
in response to receiving a query for obtaining data based on the first graph and according to the second data schema, generate a merged graph based on merging the first graph data and the second graph data; and
obtain a result for the query based on traversing the merged graph.

2. The system of claim 1, wherein the request for modifying the first graph is associated with evaluating a feature candidate for a machine learning model, and wherein executing the instructions further causes the system to:
perform one or more simulations for evaluating the feature candidate; and
determine to use the feature candidate as an input feature for the machine learning model based on an outcome from the one or more simulations.

3. The system of claim 2, wherein performing the one or more simulations comprises executing a plurality of queries on the first graph according to the second data schema.

4. The system of claim 2, wherein executing the instructions further causes the system to configure the machine learning model to accept input data corresponding to the feature candidate.

5. The system of claim 1, wherein executing the instructions further causes the system to:
receive, from a second device, a second request for a second change to the first graph schema;
without modifying the first graph, generate (i) a third graph schema based on modifying the first graph schema according to the second change and (ii) third graph data based on a difference between the first data schema and the third data schema;
in response to receiving a second query according to the third data schema, generate a second merged graph based on merging the first graph data and the third graph data; and
obtain a second result for the second query based on traversing the second merged graph.

6. The system of claim 1, wherein the merged graph is a first merged graph, and wherein executing the instructions further causes the system to:
generate a first simulation result based on performing one or more first simulations on the first merged graph;
generate a second simulation result based on performing one or more second simulations on a second merged graph, the second merged graph generated based on modifying a portion of the first graph according to a third graph schema; and
determine a set of input features for a machine learning model based on a comparison between the first simulation result and the second simulation result.

7. The system of claim 6, wherein executing the instructions further causes the system to configure the machine learning model to accept input data corresponding to the set of input features.

8. A method, comprising:
determining, by a computer system, that data corresponding to a feature candidate of a machine learning model is not accessible from a first graph, wherein the first graph comprises first graph data representing relationships among a plurality of assets associated with a service provider, wherein the first graph was generated according to a first graph schema that defines one or more vertex types and one or more edge types, and wherein the first graph comprises a plurality of vertices corresponding to the one or more vertex types and a plurality of edges corresponding to the one or more edge types;
without modifying the first graph, generating, by the computer system, (i) a second graph schema based on modifying the first graph schema to include at least one of an additional vertex type or an additional edge type for the feature candidate and (ii) second graph data comprising at least one of an additional vertex or an additional edge corresponding to the second graph schema;
in response to receiving a query for obtaining the data corresponding to the feature candidate, generating, by the computer system, a merged graph based on merging the first graph data and the second graph data; and
generating, by the computer system, a result for the query based on traversing the merged graph.

9. The method of claim 8, wherein the second graph schema defines the additional edge type, and wherein the generating the merged graph comprises:
adding one or more edges corresponding to the additional edge type to the first graph based on the second graph data.

10. The method of claim 8, wherein the second graph schema defines an additional vertex type, and wherein the generating the merged graph comprises:
adding one or more vertices corresponding to the additional vertex type to the first graph based on the second graph data.

11. The method of claim 8, wherein the first graph data is updated based on transactions conducted through the service provider, and wherein the second graph data is not updated based on the transactions conducted through the service provider.

12. The method of claim 8, further comprising:
evaluating a quality of the feature candidate for the machine learning model based on the result; and
configuring the machine learning model based on the evaluating.

13. The method of claim 12, further comprising:
determining that the quality of the feature candidate exceeds a threshold, wherein the configuring the machine learning model comprises configuring the machine learning model to accept input data corresponding to the feature candidate.

14. The method of claim 12, further comprising:
determining that the quality of the feature candidate is below a threshold, wherein the configuring the machine learning model comprises configuring the machine learning model to accept input data corresponding to a set of input features excluding the feature candidate.

15. A non-transitory machine-readable medium having stored thereon machine-readable instructions executable to cause a machine to perform operations comprising:
determining that data corresponding to a feature candidate of a machine learning model is missing from a first graph, wherein the first graph comprises first graph data representing relationships among a plurality of assets associated with a service provider, wherein the first graph was generated according to a first graph schema that defines one or more vertex types and one or more edge types, and wherein the first graph comprises a plurality of vertices corresponding to the one or more vertex types and a plurality of edges corresponding to the one or more edge types;
without modifying the first graph, generating (i) a second graph schema based on modifying the first graph schema to include at least one of an additional vertex type or an additional edge type for the feature candidate and (ii) second graph data comprising at least one of an additional vertex or an additional edge corresponding to the second graph schema;
receiving a query for obtaining the data corresponding to the feature candidate;
generating a merged graph based on merging the first graph data and the second graph data; and
generating a result for the query based on traversing the merged graph.

16. The non-transitory machine-readable medium of claim 15, wherein the operations further comprise:
performing one or more simulations for evaluating the feature candidate based on the merged graph; and
determining to use the feature candidate as an input feature for the machine learning model based on an outcome from the one or more simulations.

17. The non-transitory machine-readable medium of claim 16, wherein the performing the one or more simulations comprises executing a plurality of queries against the merged graph.

18. The non-transitory machine-readable medium of claim 16, wherein the operations further comprise configuring the machine learning model to accept input data corresponding to the feature candidate.

19. The non-transitory machine-readable medium of claim 15, wherein the merged graph is a first merged graph, wherein the feature candidate is a first feature candidate, and wherein the operations further comprise:
generating a first simulation result based on performing one or more first simulations on the first merged graph;
generating a second simulation result based on performing one or more second simulations on a second merged graph, wherein the second merged graph is generated for a second feature candidate based on modifying the first graph according to a third graph schema; and
determining a set of input features for a machine learning model based on a comparison between the first simulation result and the second simulation result, wherein the set of input features includes one of the first feature candidate or the second feature candidate, but not both.

20. The non-transitory machine-readable medium of claim 19, wherein the operations further comprise configuring the machine learning model to accept input data corresponding to the set of input features.
